(19) United States
(12) Patent Application Publication
(10) Pub. No.: US 2007/0080306 A1
(43) Pub. Date: Apr. 12, 2007

(54) VIDEO SURVEILLANCE CAMERA WITH SOLAR DETECTOR

(76) Inventor: Sung-Ken Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/566,244

(22) Filed: Dec. 4, 2006

(51) Int. Cl. G01J 1/00

(52) U.S. Cl. 250/493.1; 348/143

(57) ABSTRACT

A video surveillance camera has an infrared (IR) light emitting diode (LED) for emitting IR light, and a solar detector for detecting visible light. And the video surveillance camera can control the infrared light emitting diode to emit the IR light according to a level of visible light detected by the solar detector. Therefore, the video surveillance camera can fully turn the IR LED off or on when the level of visible light changes, even in the presence of invisible light.

### BACKGROUND OF THE INVENTION

1. Field of the Invention

The present invention relates to a video surveillance camera, and more particularly, to a video surveillance camera with a solar detector for enabling an infrared light emitting diode of the video surveillance camera.

2. Description of the Prior Art

Typical video surveillance cameras use infrared (IR) light emitting diodes (LED) as a light source when visible light is insufficient to obtain a discernable picture. To enable the infrared LEDs, the video surveillance camera typically includes a photoresistor, a photodiode, or a phototransistor, which generates a signal based on a level of visible and invisible light detected. More recently, to comply with the Restrictions on Hazardous Substances (RoHS), the photoresistor, which typically contains lead (Pb), is generally being replaced by the photodiode or the phototransistor.

Please refer to FIG. 1, which is a diagram of a video surveillance camera 100 according to the prior art. The video surveillance camera 100 comprises a panel 110, an array of IR LEDs 112 attached to the panel 110, a screen 120 for shielding a camera lens, and a photodiode/phototransistor 114 for detecting light. When the photodiode/phototransistor 114 detects the light, the photodiode/phototransistor 1 14 generates an electrical signal, which is used to turn off the IR LEDs 112. When the light detected by the photodiode/phototransistor 114 is at a sufficiently low level, the photodiode/phototransistor 114 generates a signal used to turn on the IR LEDs 11 2.

While the photodiode and the phototransistor are both capable of detecting the level of ambient visible light, and generating the signals based on a result of the detection, IR light emitted by the infrared LEDs that reflects off of the screen 120 that covers the photodiode/phototransistor 114 and the infrared LEDs can also be detected by the photodiode/phototransistor 114. Thus, even though the level of the visible light is relatively low, the infrared light will still produce a signal in the photodiode/phototransistor 114 due to detected invisible light, and the infrared LEDs may not be turned fully on. To overcome this problem, the prior art typically adds a gasket 116 to the photodiode/phototransistor 114, and presses the photodiode/phototransistor 114 against the screen 120, so as to shield the phototransistor/photodiode 114 from the IR light reflected off of the screen 120, thereby reducing the amount of infrared light detected by the phototransistor/photodiode 114. However, this measure is not completely effective, and infrared light is still able to reach the photodiode/phototransistor 114, not to mention that installation of the gasket 116 requires great care to ensure proper shielding, which complicates assembly of the video surveillance camera.

### SUMMARY OF THE INVENTION

According to the present invention, a video surveillance camera comprises an IR LED for emitting IR light, a solar detector for detecting light, and means for controlling the IR LED to emit the IR light according to a level of light detected by the solar detector.

According to the present invention, a video surveillance camera comprises an IR LED array for emitting IR light, a solar detector for detecting light, and means for controlling the IR LED array to emit the IR light according to a level of light detected by the solar detector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video surveillance camera according to the prior art.

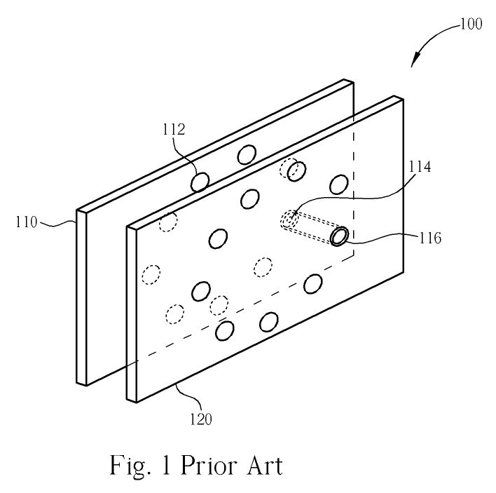

FIG. 2 is a diagram of an IR LED panel according to the present invention.

FIG. 3 is a diagram of a video surveillance camera according to the present invention.

### DETAILED DESCRIPTION

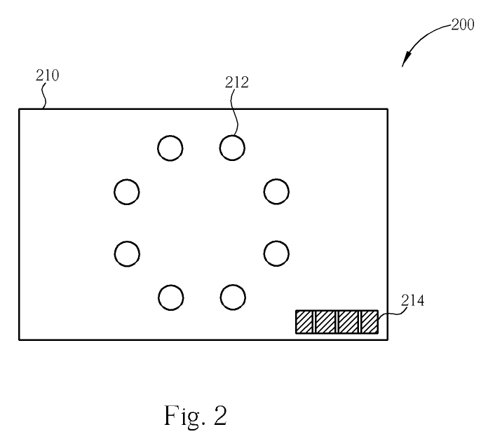

Please refer to FIG. 2, which is a diagram of an IR LED panel 200 according to the present invention. The IR LED panel 200 comprises a panel 210, an array of IR LEDs 212, and a solar panel 214. The IR LEDs 212 are attached to the panel, and generate IR light picked up by a lens of a video camera. The solar panel 214, a specific type of solar detector, detects visible light from the Sun, and generates an electrical signal based on a level of light detected. The IR LED panel 200 further comprises means for controlling the IR LEDs 212 to emit the IR light according to the level of light detected by the solar panel 214. The means for controlling the IR LEDs 212 can be hardware means, e.g. a comparator, a switch, or a microcontroller, software means, or firmware means.

When the level of light detected by the solar panel 21 4 is higher than an upper threshold, the means for controlling the IR LEDs 212 to emit the IR light turns off the IR LEDs 212. As the level of light detected by the solar panel 214 drops below the upper threshold, the means for controlling the IR LEDs 212 to emit the IR light will begin to turn on the IR LEDs 212 and control the IR LEDs 212 to emit an intensity of the IR light corresponding to the level of light detected by the solar panel 214. When the level of light detected by the solar panel 214 is lower than a lower threshold, the means for controlling the IR LEDs 212 to emit the IR light will turn the IR LEDs 212 fully on, i.e. the intensity of the IR light emitted by the IR LEDs 212 will no longer increase beyond a maximum intensity.

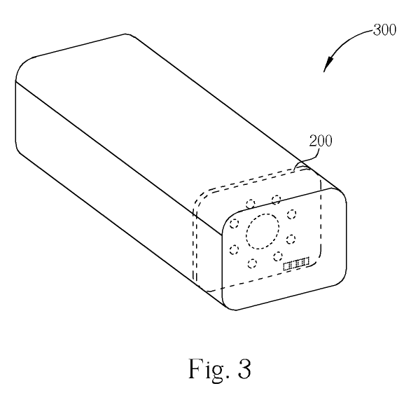

Although the array of IR LEDs 212 is used in the preferred embodiment of the present invention, only one IR LED 212 is required to enable the present invention IR LED panel 200. As shown in FIG. 3, the IR LED panel 200 is used in a video surveillance camera 300 comprising the IR LED panel 200. Also, though the solar panel 214 is used to detect the visible light from the Sun, the solar panel 214 is not a limitation of the present invention. Any light detecting element that only generates a signal based on the level of light within the visible range could be used in the present invention. Finally, the solar panel 214 shown in FIG. 2 and FIG. 3 is shown with a plurality of cells, however this is not a limitation on the present invention, as a solar panel with only one cell is also effective to achieve the goal of the present invention. The shape of the solar panel 214 is also not limiting on the present invention. The goal of the present invention could also be achieved with solar panels of other shapes, e.g. circular, elliptical, triangular, or pentagonal solar panels, etc. Any light detecting element that produces an electrical response corresponding to incident visible light is sufficient to achieve the goal of the present invention.

Compared to the prior art, the solar panel 214 does not produce the electrical signal according to the IR light incident on the solar panel. Thus, the present invention video surveillance camera can turn the IR LEDs fully on when the visible light detected by the solar panel 214 is at a sufficiently low level. Installation of the solar panel 214 eliminates the need for the gasket of the prior art, and provides a more appropriate means for detecting visible light than the photodiode/phototransistor of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video surveillance camera comprising:
an IR LED for emitting IR light;
a solar detector for detecting light; and
means for controlling the IR LED to emit the IR light according to a level of light detected by the solar detector.

2. The video surveillance camera of claim 1, wherein the solar detector is a solar panel.

3. The video surveillance camera of claim 1, wherein the means for controlling the IR LED to emit the IR light according to the level of light detected by the solar detector comprises means for enabling or disabling the IR LED according to the level of light detected by the solar detector.

4. The video surveillance camera of claim 1, wherein the means for controlling the IR LED to emit the IR light according to the level of light detected by the solar detector comprises means for controlling the IR LED to emit IR light at an intensity corresponding to the level of light detected by the solar detector.

5. A video surveillance camera comprising:
an IR LED array for emitting IR light;
a solar detector for detecting light; and
means for controlling the IR LED array to emit the IR light according to a level of light detected by the solar detector.

6. The video surveillance camera of claim 5, wherein the solar detector is a solar panel.

7. The video surveillance camera of claim 5, wherein the means for controlling the IR LED array to emit the IR light according to the level of light detected by the solar detector comprises means for enabling or disabling the IR LED array according to the level of light detected by the solar detector.

8. The video surveillance camera of claim 5, wherein the means for controlling the IR LED array to emit the IR light according to the level of light detected by the solar detector comprises means for controlling the IR LED array to emit the IR light at an intensity corresponding to the level of light detected by the solar detector.
